(19) United States
(12) Patent Application Publication
(10) Pub. No.: US 2024/0093714 A1
(43) Pub. Date: Mar. 21, 2024

(54) U-BOLT, CONSTRUCTION METHOD, AND MEASURING DEVICE

(71) Applicant: NIPPON TELEGRAPH AND TELEPHONE CORPORATION, Tokyo (JP)

(72) Inventors: Daiki KOBAYASHI, Tokyo (JP); Atsushi ARATAKE, Tokyo (JP); Yuta IKEGUCHI, Tokyo (JP)

(73) Assignee: NIPPON TELEGRAPH AND TELEPHONE CORPORATION, Tokyo (JP)

(21) Appl. No.: 18/274,660

(22) PCT Filed: Jan. 29, 2021
(86) PCT No.: PCT/JP2021/003356

§ 371 Date: Jul. 27, 2023

(51) Int. Cl. F16B 31/02; F16L 3/10

(52) U.S. Cl. CPC F16B 31/02; F16L 3/1091

(57) ABSTRACT

A U-bolt (10) according to the present disclosure includes a pair of shaft parts (11) aligned in a first direction and extending in a second direction orthogonal to the first direction; a bridge part (12) which connects one ends of each of the pair of shaft parts (11); and a first pair of strain gauges (14) which are stuck to at least one shaft part (11) of the pair of shaft parts (11) to face each other with the shaft part (11) sandwiched in the first direction, and which output a signal corresponding to bending of the shaft part (11) in the second direction.

### TECHNICAL FIELD

The present disclosure relates to a U-bolt, an installing method, and a measurement device.

### BACKGROUND ART

In related art, a U-bolt has been used to fix a fastened object such as a pipe to a fastening base such as a frame or a wall surface. The U-bolt is a U-shaped bolt in which two linear shaft parts are connected by a bridge part. By inserting the shaft parts of the U-bolt into two through-holes provided in the fastening base while the fastened object is surrounded by the U-bolt, and by fastening from each end part of the two shaft parts with a nut, the fastened object can be sandwiched between the U-bolt and the fastening base and fixed.

When the fastened object is fixed to the fastening base by the U-bolt, it is necessary to fix the U-bolt perpendicularly to the fastening base. However, in many cases, the U-bolt is mounted in an inclined manner in terms of structure. When the U-bolt is mounted in an inclined state, the U-bolt may cause breakage due to excessive stress.

A technique for providing a piezoelectric patch on a washer inserted into a bolt and measuring a fastening force of the bolt on the basis of a pressure measured by the piezoelectric patch is described in NPL 1. In addition, a technique for embedding a piezoelectric sensor in a shaft part of a bolt and measuring a fastening force of the bolt on the basis of a strain of the shaft part of the bolt measured by the piezoelectric sensor is described in NPL 2.

### CITATION LIST

### Non Patent Literature

[NPL 1] H. Yin, T. Wang, D. Yang, S. Liu, J. Shao, and Y. Li, “A smart washer for bolt looseness monitoring based on piezoelectric active sensing method,” Appl. Sci., vol. 6, No. 11, 2016
[NPL 2] N. Shimoi, C. H. Cuadra, H. Madokoro, and M. Saijo, “Simple Smart Piezoelectric Bolt Sensor for Structural Monitoring of Bridges,” Int. J. Instrum. Sci., vol. 1, No. 5, pp. 78-83, 2013

### SUMMARY OF INVENTION

### Technical Problem

The techniques described in the above-mentioned NPLs 1 and 2 are techniques for measuring the fastening force of a linear bolt, and do not allow confirmation of the fastening state of a U-bolt to a fastening base.

An object of the present disclosure, which has been made in view of the above-mentioned problems, is to provide a U-bolt, an installing method, and a measurement device that can confirm a fastening state of the U-bolt to a fastening base.

### Solution to Problem

In order to solve the above problem, a U-bolt according to the present disclosure is a U-bolt which includes a pair of shaft parts aligned in a first direction and extending in a second direction orthogonal to the first direction, and a bridge part which connects one ends of each of the pair of shaft parts. The U-bolt includes a first pair of strain gauges which are stuck to at least one shaft part of the pair of shaft parts to face each other while sandwiching the shaft part in the first direction, and which output a signal corresponding to bending of the shaft part in the second direction.

In addition, in order to solve the above problem, an installing method according to the present disclosure is an installing method for fastening a U-bolt which includes a pair of shaft parts aligned in a first direction and extending in a second direction orthogonal to the first direction, and a bridge part which connects one ends of each of the pair of shaft parts, in which, by the measurement device, a pair of strain gauges which output a signal corresponding to bending of the shaft part in the second direction are stuck to at least one shaft part of the pair of shaft parts to face each other while sandwiching the shaft part in the first direction, the method including the steps of detecting a strain in the second direction of the shaft part to which the pair of strain gauges are stuck, on the basis of a signal output from each of the pair of strain gauges in response to fastening of a nut from the other end of the shaft part to each of the pair of shaft parts inserted into a pair of through-holes provided in a fastening base; and outputting information on fastening of the nut to the shaft part on the basis of the detected strain.

In addition, in order to solve the above problem, a measurement device according to the present disclosure is a measurement device for fastening a U-bolt which includes a pair of shaft parts aligned in a first direction and extending in a second direction orthogonal to the first direction, and a bridge part which connects one ends of each of the pair of shaft parts, in which a pair of strain gauges which output a signal corresponding to bending of the shaft part in the second direction are stuck to at least one shaft part of the pair of shaft parts to face each other while sandwiching the shaft part in the first direction, and the measurement device includes a detection unit which detects a strain in the second direction of the shaft part to which the pair of strain gauges are stuck, on the basis of a signal output from each of the pair of strain gauges in response to fastening of a nut from the other end of the shaft part to each of the pair of shaft parts inserted into a pair of through-holes provided in a fastening base; and an output unit that outputs information on fastening of the nut to the shaft part on the basis of the strain detected by the detection unit.

### Advantageous Effects of Invention

According to the U-bolt, the installing method, and the measurement device according to the present disclosure, a fastening state of the U-bolt to the fastening base can be confirmed.

### BRIEF DESCRIPTION OF DRAWINGS

FIG. 1 is a diagram showing a configuration example of a U-bolt according to a first embodiment of the present disclosure.

FIG. 2 is a diagram showing a state in which a fastened object is fixed to a fastening base by the U-bolt shown in FIG. 1.

FIG. 3 is a diagram showing a shaft part shown in FIG. 1 in a direction of an X-axis.

FIG. 4A is a diagram for explaining a tensile force and a compressive force acting on the U-bolt when an axial force acting on the shaft part shown in FIG. 1 is uniform.

FIG. 4B is a diagram for explaining the tensile force and the compressive force acting on the U-bolt when an axial force acting on the shaft part shown in FIG. 1 is non-uniform.

FIG. 5 is a diagram showing an example of a hardware configuration of the measurement device according to the present embodiment.

FIG. 6 is a diagram showing an example of a functional configuration of a measurement device according to the present embodiment.

FIG. 7 is a diagram showing another configuration example of the U-bolt according to a first embodiment of the present invention.

FIG. 8 is a flow chart showing an example of an operation of a measurement device shown in FIG. 6.

FIG. 9 is a diagram showing an example of the configuration of the U-bolt according to a second embodiment of the present invention.

FIG. 10 is a cross-sectional view along the line C-C shown in FIG. 9.

### DESCRIPTION OF EMBODIMENTS

A description will be given below of embodiments of the present disclosure with reference to the drawings.

### First Embodiment

(Configuration of U-bolt)

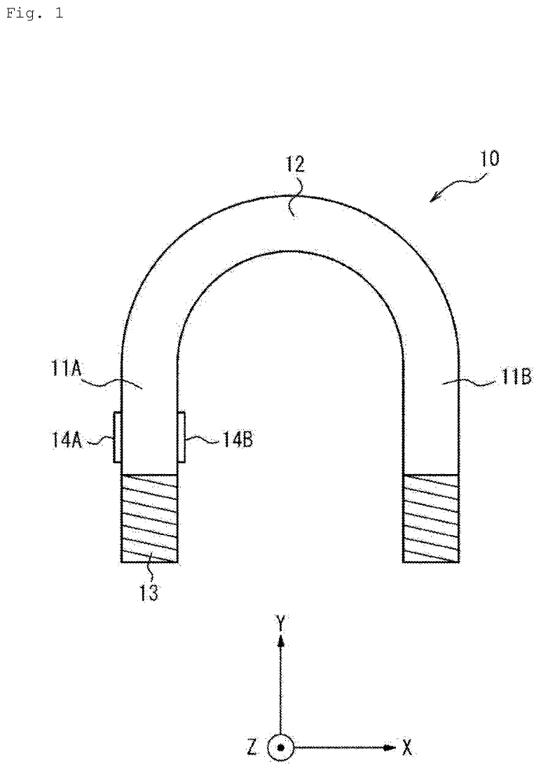

FIG. 1 is a diagram showing a configuration example of a U-bolt 10 according to a first embodiment of the present disclosure.

As shown in FIG. 1, the U-bolt 10 according to the present disclosure includes a pair of shaft parts 11A and 11B, a bridge part 12, and strain gauges 14A and 14B.

The shaft parts 11A and 11B are disposed in a prescribed direction and extend in a direction orthogonal to the prescribed direction. Hereinafter, as shown in FIG. 1, a direction in which the shaft parts 11A and 11B are disposed side by side is referred to as an X-axis direction (a first direction), a direction in which the shaft parts 11A and 11B extend is referred to as a Y-axis direction (a second direction), and a direction orthogonal to the X-axis direction and the Y-axis direction is referred to as a Z-axis direction (a third direction). Hereinafter, when no distinction is made between the shaft parts 11A and 11B, they are referred to as a shaft part 11. In the following description, the shaft parts 11A and 11B are referred to as a pair of shaft parts 11.

One end of the shaft part 11A and one end of the shaft part 11B are connected by a bridge part 12 having a shape curved in a semicircular shape. One end of the shaft part 11A and one end of the shaft part 11B are connected by the bridge part 12, so that the U-bolt 10 forms a U-shape. A screw part 13 having a screw thread structure is formed on the other end sides of each of the shaft parts 11A and 11B.

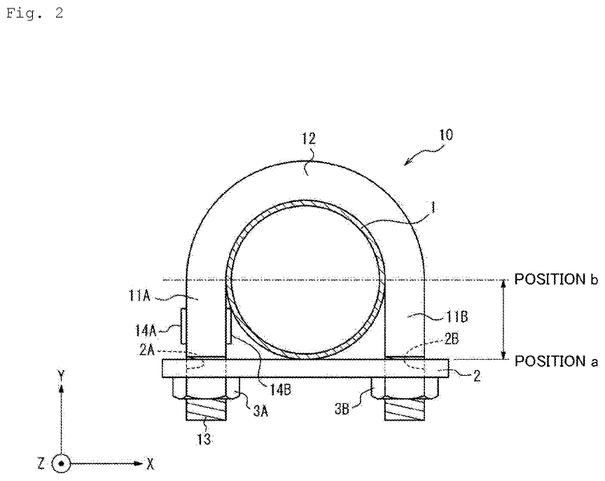

As shown in FIG. 2, a fastened object 1 such as piping is disposed inside the U-shaped U-bolt 10 (in the space surrounded by the pair of inner shaft parts 11 and the bridge part 12). In a state in which the fastened object 1 is disposed inside, the shaft parts 11A and 11B are inserted into a pair of through-holes 2A and 2B provided in a fastening base 2 such as support hardware from one surface side of the fastening base 2. When the shaft parts 11A and 11B are inserted into the through-holes 2A and 2B, the screw parts 13 of the shaft parts 11A and 11B protrude to the other surface side of the fastening base 2. When nuts 3A and 3B having screw thread structures to be screwed onto the screw thread structures of the screw parts 13 are fastened to the screw parts 13 of the shaft parts 11A and 11B protruding from the other surface side of the fastening base 2, the fastened object 1 is fixed by being sandwiched between the U-bolt 10 and the fastening base 2. Hereinafter, when no distinction is made between the nuts 3A and 3B, they are referred to as a nut 3.

The U-bolt 10 according to the present embodiment further includes strain gauges 14A and 14B as shown in FIG. 1. In the example shown in FIG. 1, the strain gauges 14A and 14B are stuck to the shaft part 11A.

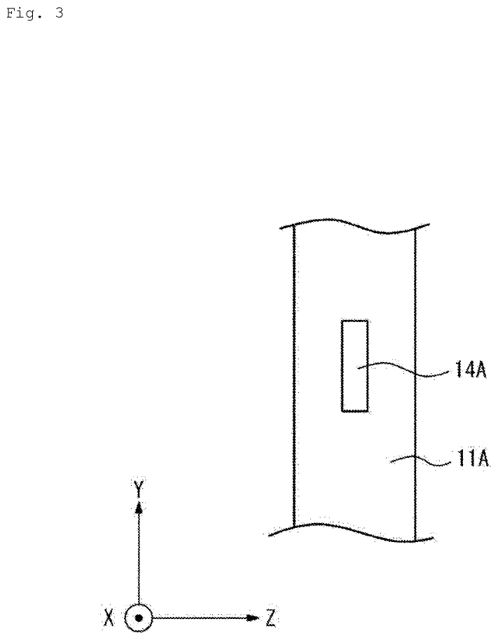

FIG. 3 is a diagram of the shaft part 11A viewed facing the shaft part 11B in the X-axis direction. That is, FIG. 3 is a diagram of a surface on the outside (an opposite side to the side on which the fastened object 1 is disposed) of the shaft part 11A from the X-axis direction. As shown in FIG. 3, a strain gauge 14A is stuck to the outer surface of the shaft part 11A at a position substantially at the center in the Z-axis direction of the shaft part 11A.

As shown in FIGS. 1 and 2, the strain gauge 14B is stuck to the inside of the shaft part 11A to face the strain gauge 14A across the shaft part 11A. In this way, the two strain gauges 14A and 14B opposite to each other across the shaft part 11A in the X-axis direction are stuck to the shaft part 11A as a pair. Hereinafter, when the strain gauge 14A and the strain gauge 14B are not distinguished from each other, they are referred to as the strain gauge 14. In the following description, the strain gauge 14A disposed on the outside in the X-axis direction and the strain gauge 14B disposed on the inside in the X-axis direction are combined and referred to as a pair of strain gauges 14.

The strain gauge 14 is deformed (pulled and compressed) depending on bending of the shaft part 11 to which the strain gauge 14 is stuck, and outputs a signal (voltage signal) corresponding to the deformation. Specifically, the strain gauge 14 is stuck to the shaft part 11 to output a signal corresponding to bending in the Y-axis direction of the shaft part 11 to which the strain gauge 14 is stuck. Thus, the U-bolt 10 according to the present embodiment includes a pair of strain gauges 14 (a first pair of strain gauges) which are stuck to one shaft part 11A of the pair of shaft parts 11 opposite to each other while sandwiching the shaft part 11A in the X-axis direction, and output a signal corresponding to the bending of the shaft part 11A in the Y-axis direction.

As shown in FIG. 2, in a state in which a pair of shaft parts 11 are inserted into a pair of through-holes 2A and 2B provided in the fastened object 2 and the fastening object 1 is sandwiched and fixed between the U-bolt 10 and one surface of the fastened object 2, all or part of the strain gauge 14 is located between a position (position a) of one surface of the fastened object 2 and a position (position b) of the boundary between the shaft part 11 and the bridge part 12. By this arrangement, the strain gauge 14 can output a signal corresponding to the bending of the stuck shaft part 11 in the Y-axis direction. The scale of the strain gauge 14 in FIG. 1 is not necessarily the same as the actual scale. This applies similarly to FIGS. 2 and 3.

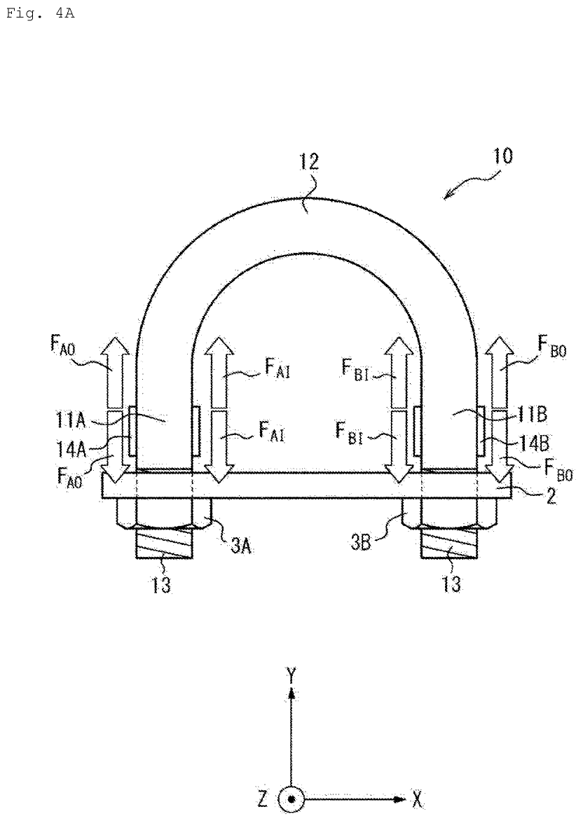

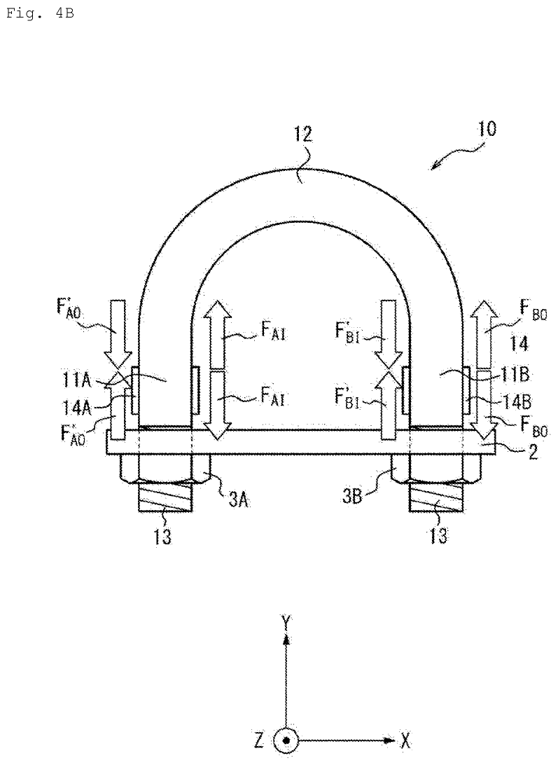

FIGS. 4A and 4B are diagrams showing a state in which the U-bolt 10 is fastened to the fastened object 2. FIG. 4A is a diagram showing tensile force and compressive force acting on the U-bolt 10 when the force (axial force) for tightening the shaft parts 11A and 11B is uniform. FIG. 4B shows tensile force and compressive force acting on the U-bolt 10 when axial force acting on the shaft parts 11A and 11B is not uniform. In FIGS. 4A and 4B, description of the strain gauge 14 is omitted.

As shown in FIG. 4A, when the shaft parts 11A and 11B are uniformly fastened to the fastened object 2, tensile forces F_{AO}, F_{AI}, F_{BO}, and F_{BI} of the same magnitude are generated on the outside and inside of each of the shaft part 11A and the shaft part 11B. Therefore, axial forces acting on each of the shaft part 11A and the shaft part 11B are almost uniform. On the other hand, as shown in FIG. 4B, when the shaft parts 11A and 11B are not uniform in the fastened object 2, compression forces F′_{AO} and F′_{BI} are generated on each of the outside of the shaft part 11A and the inside of the shaft part 11B, and tensile forces F′_{AI} and F′_{BO} are generated on each of the inside of the shaft part 11A and the outside of the shaft part 11B. Therefore, axial force acting on the shaft part 11A and the shaft part 11B is not uniform. In order to firmly fix the fastening object, axial force acting on the shaft part 11A and the shaft part 11B needs to be made almost uniform. Thus, the strain gauge 14 is stuck to the shaft part 11 of the strain gauges 14A and 14B, and when strain is detected from an output signal of the strain gauges 14A and 14B, a worker can confirm whether axial force acting on the shaft part 11A and the shaft part 11B of the U-bolt 10 to the fastened object 2 is uniform. Thus, a worker can fasten the U-bolt 10 to the fastened object 2 appropriately by fastening the shaft part 11 with the nut 3 so that axial force acting on the shaft part 11A and the shaft part 11B is uniform.

(Hardware Configuration of Measurement Device)

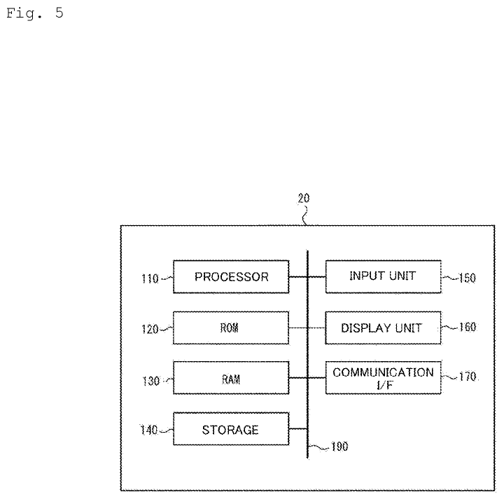

FIG. 5 is a diagram showing an example of a hardware configuration of a measurement device 20 according to an embodiment of the present disclosure. FIG. 5 shows an example of the hardware configuration of the measurement device 20 when the measurement device 20 is constituted by a computer capable of executing program instructions. The computer may be a general-purpose computer, a dedicated computer, a workstation, a personal computer (PC), an electronic note pad or the like. The program instructions may be program code, code segments, and the like for executing the required tasks. When the measurement device 20 is a smartphone, since a worker can easily carry the measurement device 20 to a place in which the U-bolt 10 is fastened to the fastened object 2 in installation or inspection of the U-bolt 10, convenience is improved.

As shown in FIG. 5, the measurement device 20 has a processor 110, a read only memory (ROM) 120, a random access memory (RAM) 130, a storage 140, an input unit 150, a display unit 160, and a communication interface (I/F) 170. Each configuration is connected to each other via a bus 190 to be communicable with each other. Specifically, the processor 110 includes a central processing unit (CPU), a micro processing unit (MPU), a graphics processing unit (GPU), a digital signal processor (DSP), a System on a Chip (SoC), and the like, and may be constituted by a plurality of processors of the same kind or different kinds.

The processor 110 executes control of each configuration and various calculation processing. More specifically, the processor 110 reads a program from the ROM 12 or the storage 140 and executes the program using the RAM 13 as a working area. The processor 110 controls the respective configurations described above and performs various types of calculation processing in accordance with the program stored in the ROM 120 or the storage 140. In this embodiment, the ROM 120 or the storage 140 stores a program according to the present disclosure.

The program may be provided in the form of being stored on a non-transitory storage medium such as a compact disk read only memory (CD-ROM), a digital versatile disk read only memory (DVD-ROM), or a universal serial bus (USB) memory. In addition, the program may be downloaded from an external device over a network.

The ROM 120 stores various programs and various types of data. The RAM 130 is a work area and temporarily stores a program or data. The storage 140 is configured by a hard disk drive (HDD) or a solid state drive (SSD), and stores various programs including an operating system and various types of data.

The input unit 150 includes a pointing device such as a mouse and a keyboard, and is used to input various types of input. The display unit 160 is a liquid crystal display, for example, and displays various types of information. By adopting a touch panel system, the display unit 160 may also function as the input unit 150.

The communication interface 170 is an interface for communicating with other devices such as an external device (not shown), and for example, standards such as Ethernet (registered trademark), FDDI, and Wi-Fi (registered trademark) are used.

(Functional Configuration of Measurement Device)

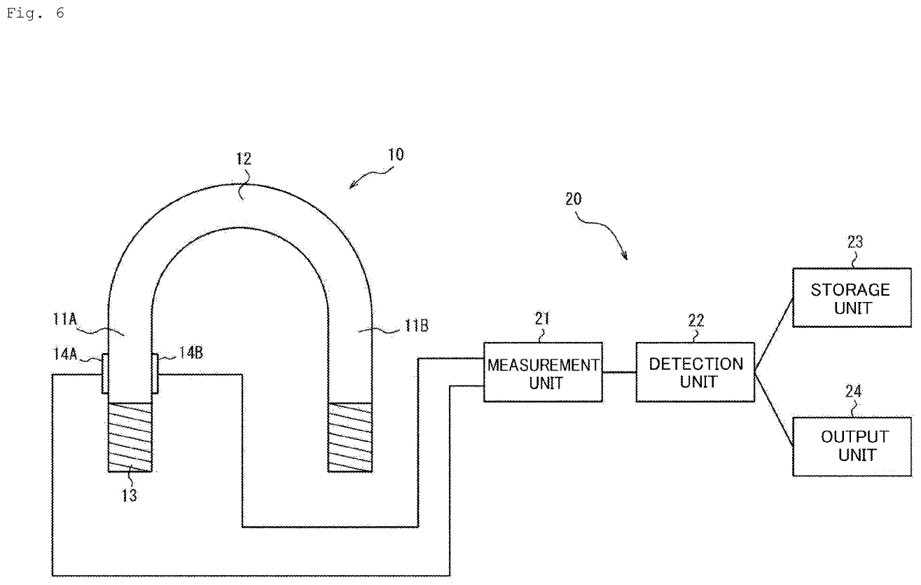

Next, a functional configuration of the measurement device 20 according to the present disclosure will be described with reference to FIG. 6.

FIG. 6 shows an example of a functional configuration of the measurement device 20 according to the present disclosure. The measurement device 20 according to the present disclosure measures strain of the shaft part 11 of the U-bolt 10, and outputs information on a state of fastening of a nut 3 to the shaft part 11 according to a measurement result.

As shown in FIG. 6, the measurement device 20 according to the present disclosure includes a measurement unit 21, a detection unit 22, a recording unit 23, and an output unit 24. The measurement unit 21 and the detection unit 22 constitute a control unit (controller). The control unit may be constituted by dedicated hardware such as an application specific integrated circuit (ASIC) and a field-Programmable Gate Array (FPGA), or may be constituted by a processor as described above. The recording unit 23 is constituted by, for example, a RAM 130 or a storage 140. The output unit 24 may include, for example, a display unit 160.

The measurement unit 21 is connected to a pair of strain gauges 14 stuck to the shaft part 11 of the U-bolt 10 via a lead wire, and acquires signals output from each of the pair of strain gauges 14. Specifically, the measurement unit 21 measures a voltage change accompanying the expansion and contraction of each of the strain gauges 14A and 14B. Since the method of measuring the voltage change accompanying the expansion and contraction of the strain gauge 14 is the same as that used in a general strain measuring instrument, the description thereof will not be provided. The measurement unit 21 outputs the measurement results to the detection unit 22.

The detection unit 22 detects a strain (bending) in the Y-axis direction of the shaft part 11 to which the pair of strain gauges 14 are stuck, on the basis of the signal acquired by the measurement unit 21. That is, the detection unit 22 detects the strain of the shaft part 11A to which the pair of strain gauges 14 are stuck, based on signals output from the pair of strain gauges 14 in response to the fastening of the nut 3 from the other end of the shaft part 11.

The recording unit 23 records a detection result of the detection unit 22. By doing so, for example, it is possible to leave a trail of completion of normal construction

(Fastening of the U-Bolt 10).

The output unit 24 outputs information on fastening of the nut 3 to the shaft part 11 on the basis of a detection result of the detection unit 22.

In the example shown in FIG. 6, the detection unit 22 detects tensile force or compressive force acting on the outside and the inside of the shaft part 11A to which the pair of strain gauges 14 are stuck, on the basis of output signals of the pair of strain gauges 14. The tensile force or compressive force acting on the outside and inside of the shaft part 11A is force that occurs depending on the inclination of the shaft part 11A in the X-axis direction with respect to the fastened object 2.

The output unit 24 outputs information on fastening of the nut 3 to the shaft part 11 on the basis of a detection result of the detection unit 22. For example, when it is detected that a tensile force is acting on the outside and inside of the shaft part 11A (tensile strain is occurring) on the basis of the output signals of the pair of strain gauges 14, the output unit 24 outputs information indicating that the shaft parts 11A and 11B are uniformly fastened, as information on tightening the nut 3 to the shaft part 11.

Further, the output unit 24 generates compression strain outside the shaft part 11A on the basis of output signals of, for example, a pair of strain gauges 14, when it is detected that tensile strain is generated inside the shaft part 11A, information indicating that the shaft part 11A is fastened stronger than the shaft part 11B is output as information on fastening of the nut 3 to the shaft part 11. For example, when it is detected that tensile strain is generated on the outside of the shaft part 11A and compression strain acts on the inside of the shaft part 11A on the basis of the output signals of a pair of strain gauges 14, the output unit 24 outputs information indicating that the shaft part 11B is fastened stronger than the shaft part 11A, as information on fastening of the nut 3 to the shaft part 11.

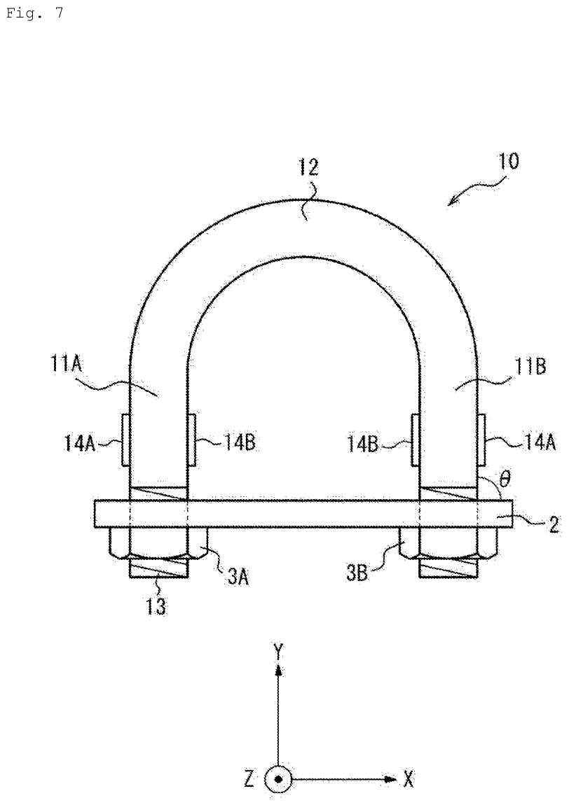

Although the above embodiment has been described using an example in which a pair of strain gauges 14 are stuck only to the shaft part 11A, the present disclosure is not limited thereto. For example, a pair of strain gauges 14 may be stuck only to the shaft part 11B. Also, for example, as shown in FIG. 7, a pair of strain gauges 14 may be stuck to both of the shaft parts 11A and 11B. Therefore, the U-bolt 10 according to the present embodiment includes a pair of strain gauges 14 which are stuck to at least one shaft part 11 of the pair of shaft parts 11 to face each other with the shaft part 11 sandwiched therebetween in the X-axis direction, and which output a signal corresponding to the bending of the shaft part 11 in the Y-axis direction. As shown in FIG. 7, when the pair of strain gauges 14 are stuck to both of the shaft parts 11A and 11B, the four strain gauges 14 are stuck to the same height (at the same position in the Y-axis direction).

As shown in FIG. 7, when the pair of strain gauges 14 are stuck to both of the shaft parts 11A and 11B, the measurement unit 21 measures changes in voltages that are output from each of the pair of strain gauges 14 stuck to the shaft part 11A and the pair of strain gauges 14 stuck to the shaft part 11B.

The detection unit 22 detects strain in the Y-axis direction of each of the pair of shaft parts 11 to which the pair of strain gauges 14 are stuck, on the basis of the measurement result of the measurement unit 21.

ε_{A} of the shaft part 11A and a strain amount ε_{B} of the shaft part 11B. Further, the detection unit 22 calculates a difference ε between the strain amount ε_{A} of the shaft part 11A and the strain amount ε_{B} of the shaft part 11B. The detection unit 22 outputs the calculated strain amount ε_{A}, strain amount ε_{B}, and a difference ε between the strain amount ε_{A} and strain amount ε_{B} to the recording unit 23. ε between the strain amount ε_{A} and the strain amount ε_{B} to the output unit 24.

Δε₁ which is a difference between the strain amount ε_{A} and a target strain ε_{T}. In this case, the detection unit 22 can further detect whether an absolute value of the target difference Δε₁ is less than a predetermined threshold. The target strain ε_{T} is a strain ε generated in the shaft part 11 on which a target axial force is applied.

When the strain gauge 14 is stuck to both shaft parts 11A and 11B, the detection unit 22 detects a first representative value and a second representative value on the basis of an output signal of the strain gauge 14 stuck to both shaft parts 11A and 11B. The detection unit 22 can detect the strain amount ε_{A} and the strain amount ε_{B} of each of both shaft parts 11A and 11B, on the basis of the first representative value and the second representative value.

In this case, the detection unit 22 can detect target differences Δε_{1A} and Δε_{1B} which are differences between each of the strain amount ε_{A} and the strain amount ε_{B} and the target strain Δε_{T} as the target difference Δε_{1B}. In this case, the detection unit 23 can further detect whether the absolute values of the target differences Δε_{1A} and Δε_{1B} are less than a predetermined threshold.

Furthermore, the detection unit 23 can detect the relative difference Δε₂, which is a difference between the strain amount ε_{A} and the strain amount ε_{B}. In this case, the detection unit 23 can further detect whether the absolute value of the relative difference Δε₂ is less than a predetermined threshold.

The output unit 24 outputs information on fastening of the nut 3 to the shaft part 11 on the basis of a detection result of the detection unit 22.

For example, when a difference ε between the strain amount ε_{A} and the strain amount ε_{B} is within a predetermined range, the output unit 24 outputs information indicating that each of the pair of shaft parts 11 is uniformly fastened, as information on fastening of the nut 3 to the shaft part 11. For example, when the difference ε between the strain amount ε_{A} and the strain amount ε_{B} is not within a predetermined range, the output unit 24 outputs information indicating that each of the pair of shaft parts 11 is not uniformly fastened, as information on fastening of the nut 3 to the shaft part 11. In this case, the output unit 24 may output a display prompting to tighten the nut 3A to the shaft part 11A or tighten the nut 3B to the shaft part 11B depending on the difference ε between the strain amount ε_{A} and the strain amount ε_{B}.

For example, when the strain directions detected by the pair of strain gauges 14 stuck to the shaft part 11A are different, or when the strain directions detected by the pair of strain gauges 14 stuck to the shaft part 11B are different, the shaft part 11 is considered to be inclined in the X-axis direction with respect to the fastened object 2. Therefore, in this case, the output unit 24 outputs information on fastening of the nut 3 to the shaft part 11 such that an angle θ in the X-axis direction formed by the shaft part 11 and the fastened object 2 is 90 degrees.

For example, when the amount of strain detected by the pair of strain gauges 14 stuck to each of the pair of shaft parts 11 is equal, and the amount of strain detected by the strain gauge 14A stuck to the shaft part 11A is not equal to the amount of strain detected by the strain gauge 14B stuck to the shaft part 11B, it is considered that the axial force acting on the shaft part 11A and the axial force acting on the shaft part 11B are different from each other. In this case, the output unit 24 outputs information on fastening of the nut 3 to the shaft part 11 to adjust fastening of the nut 3 to the shaft part 11 so that strain amounts detected by each of the pair of strain gauges 14 stuck to the shaft part 11A and the pair of strain gauges 14 stuck to the shaft part 11B are equal to each other.

In the U-bolt 10 shown in FIG. 7, by sticking the pair of strain gauges 14 to both of the shaft parts 11A and 11B, bending of both of the shaft parts 11A and 11B can be detected. In the U-bolt 10 shown in FIG. 7, since the four strain gauges 14 are stuck to the same position in the Y-axis direction, the axial force of the shaft parts 11A and 11B can be measured.

(Method for Installing U-Bolt)

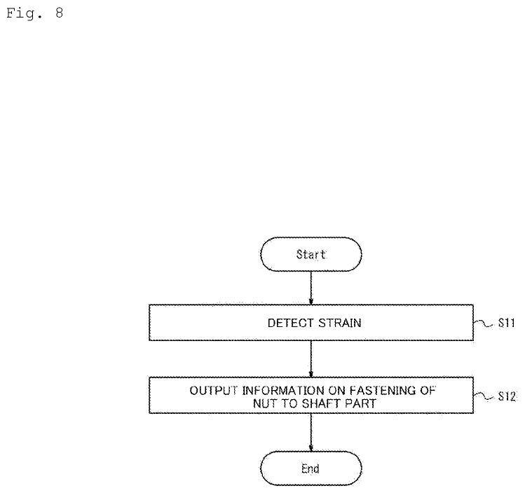

FIG. 8 is a flow chart illustrating an example of the operation of the measurement device 20 according to the present embodiment, which is a diagram for illustrating an installing method of the U-bolt 10, using the measurement device 20.

The detection unit 22 detects a strain in the Y-axis direction of the shaft part 11 to which the pair of strain gauges 14 are stuck, on the basis of the signal output from the pair of strain gauges 14 and acquired by the measurement unit 21 (step S11). As described above, the signal output from the strain gauge 14 is a signal that is output from each of the pair of strain gauges 14 in response to the fastening of the nut 3 from the other end of the shaft part 11 to each of the pair of shaft parts 11 inserted into the pair of through-holes 2A and 2B provided in the fastened object 2.

The output unit 24 outputs information on fastening of the nut 3 to the shaft part 11 on the basis of the strain detected by the detection unit 22 (step S12).

As described above, the U-bolt 10 according to the present embodiment includes a pair of strain gauges 14 which are stuck to at least one of the pair of shaft parts 11 to face each other with the shaft part 11 sandwiched therebetween in the X-axis direction, and which output a signal corresponding to bending of the shaft part 11 in the Y-axis direction.

The installing method according to the present embodiment includes a step for detecting strain (step S11), and a step for outputting information (step S12). In the step of detecting the strain, the strain in the Y-axis direction of the shaft part 11 to which the pair of strain gauges 14 are stuck is detected, on the basis of signals output from each of the pair of strain gauges 14 depending on the fastening of the nut 3 from the other end of the shaft part 11 to each of the pair of shaft parts 11 inserted into the pair of through-holes 2A and 2B provided in the fastened object 2. In the step of outputting the information, the information on the fastening of the nut 3 to the shaft part 11 is output on the basis of the strain detected by the detection unit.

The measurement device 20 according to the present embodiment includes a detection unit 22 and an output unit 24. The detection unit 22 detects the strain in the Y-axis direction of the shaft part 11 to which the pair of strain gauges 14 are stuck, on the basis of a signal output from each of the pair of strain gauges 14 depending on the fastening of the nut 3 from the other end of the shaft part 11 to each of the pair of shaft parts 11 inserted into the pair of through-holes 2A and 2B provided in the fastened object 2. The output unit 24 outputs information on fastening of the nut 3 to the shaft part 11 on the basis of the strain detected by the detection unit 22.

Signals that are output from the pair of strain gauges 14 in response to fastening of the nut 3 to the shaft part 11 of the U-bolt 10 fastened to the fastened object 2 indicate strain of the shaft part 11 due to fastening of the nut 3. By detecting the strain, the fastening state of the U-bolt 10 to the fastened object 2 can be confirmed. Further, by acquiring information on fastening of the nut 3 to the shaft part 11 on the basis of the detected strain of the shaft part 11, the U-bolt 10 can be fastened to the fastened object 2 in an appropriate fastening state. Therefore, a worker can fasten the U-bolt 10 to the fastened object 2 with high accuracy, and the fastening object 1 can be firmly fixed accordingly.

### Second Embodiment

(Configuration of U-bolt)

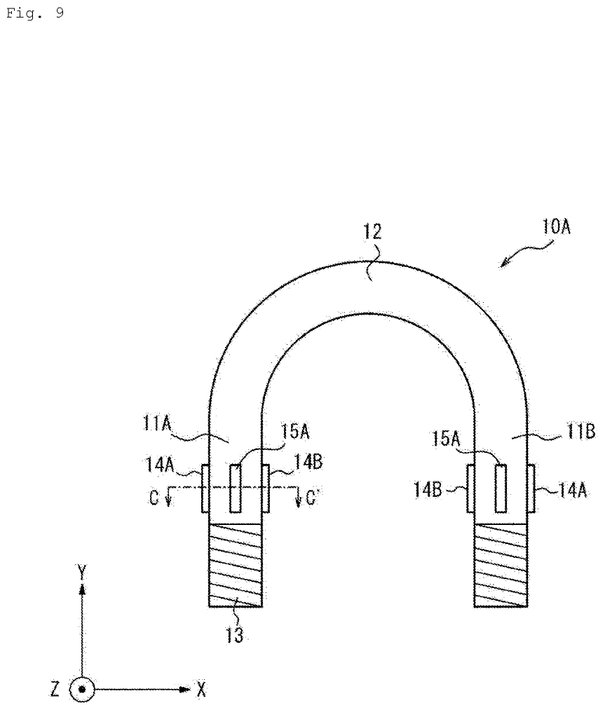

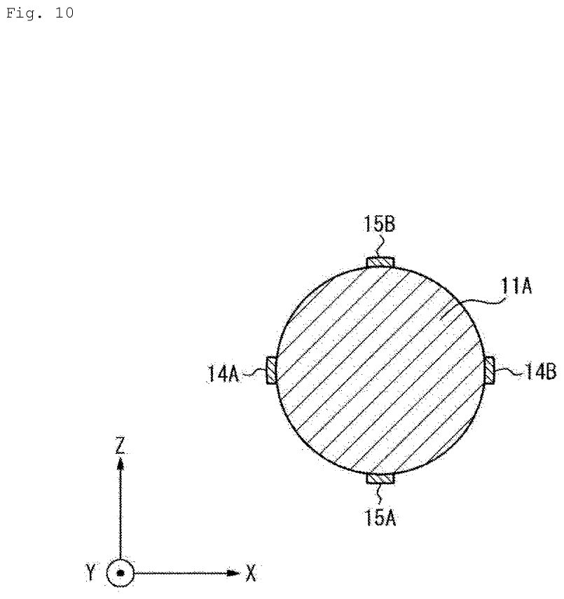

FIG. 9 is a diagram showing an example of the configuration of the U-bolt 10A according to the second embodiment. FIG. 10 is a cross-sectional view of the structure taken along a line C-C′ shown in FIG. 9. In FIGS. 9 and 10, the same configurations as those of FIG. 7 are denoted by the same reference numerals, and a description thereof will not be provided.

A U-bolt 10A according to the present embodiment further includes a strain gauge 15A and a strain gauge 15B as compared with the U-bolt 10 shown in FIG. 7.

As shown in FIG. 10, the strain gauges 15A and 15B are stuck to the shaft part 11A to face each other while sandwiching the shaft part 11A in the Z-axis direction. The strain gauge 15A and the strain gauge 15B are similarly stuck to the shaft part 11B. The strain gauges 15A and 15B output signals corresponding to the bending of the stuck shaft part 11 in the Y-axis direction, respectively. Hereinafter, the strain gauge 15A and the strain gauge 15B stuck to the shaft part 11 to face each other in the Z-axis direction are collectively referred to as a pair of strain gauges 15 (a pair of second strain gauges 15). As shown in FIG. 10, the pair of strain gauges 15 are stuck to positions at which the pair of strain gauges 14 are rotated by 90 degrees on an X-Z plane. According to the U-bolt 10A according to the present embodiment, the inclination of the U-bolt 10 can be detected even in the Z-axis direction (a turning angle direction), by providing the pair of strain gauges 15.

Although FIG. 9 shows an example in which the pair of strain gauges 15 are stuck to both of the shaft parts 11A and 11B, the present disclosure is not limited thereto. The pair of strain gauges 15 may be stuck to only one of the shaft parts 11A and 11B. That is, the U-bolt 10A according to the present embodiment further includes a pair of strain gauges 15 which are stuck to at least one shaft part 11 of the pair of shaft parts 11 to face each other with the shaft part 11 sandwiched in the Z-axis direction, and which output a signal corresponding to the bending of the shaft part 11 in the Y-axis direction.

It is preferable that all the strain gauges 14 and 15 stuck to the shaft part 11 are stuck at the same height (at the same position in the Y-axis direction). Thus, the difference between the axial force acting on the shaft part 11A and the axial force acting on the shaft part 11B can be accurately measured.

<Program>

A computer can be suitably used to function as the units of the measurement device 20 described above. Such a computer can be realized by storing a program describing the processing details for realizing the functions of each part of the measurement device 20 in a storage unit of the computer and by causing a processor of the computer to read and execute the program. That is to say, the program can cause the computer to function as the above-described measurement device 20. Further, the program can be recorded on a non-temporary recording medium. The program may also be provided via a network.

### REFERENCE SIGNS LIST

1 Fastening object
2 Fastened object
2A, 2B Through-hole
3A, 3B Nut
10 U-bolt
11A, 11B Shaft part
12 Bridge part
13 Screw part
14A, 14B, 15A, 15B Strain gauge
20 Measurement device
21 Measurement unit
22 Detection unit
23 Recording unit
24 Output unit
110 Processor
120 ROM
130 RAM
140 Storage
150 Input unit
160 Display unit
170 Communication I/F
190 Bus

1. A U-bolt, comprising:
a pair of shaft parts, wherein the pair of shaft parts is aligned in a first direction and extending in a second direction orthogonal to the first direction, and
a bridge part, wherein the bridge part connects one set of ends of each of the pair of shaft parts;
a first pair of strain gauges, wherein the first pair of strain gauges is stuck to at least one shaft part of the pair of shaft parts to face each other while sandwiching the shaft part in the first direction, and the first pair of strain gauges outputs a first voltage signal corresponding to bending of the shaft part in the second direction.

2. The U-bolt according to claim 1, further comprising:
a second pair of strain gauges, wherein the second pair of strain gauges is stuck to the at least one shaft part of the pair of shaft parts to face each other while sandwiching the shaft part in a third direction orthogonal to the first direction and the second direction, and the second pair of strain gauges outputs a second voltage signal corresponding to bending of the shaft part in the second direction.

3. The U-bolt according to claim 1,
wherein, in a state in which the pair of shaft parts are inserted into a pair of through-holes provided in a fastening base, and a fastened object is sandwiched between the U-bolt and one surface of the fastening base and fixed, the strain gauge is entirely or partially positioned between the one surface of the fastening base and a boundary between the shaft part and the bridge part.

4. A method comprising,
fastening a U-bolt,
wherein the U-bolt includes a pair of shaft parts aligned in a first direction and extending in a second direction orthogonal to the first direction, and a bridge part which connects one set of ends of each of the pair of shaft parts, and
wherein a pair of strain gauges which output a first voltage signal corresponding to bending of the shaft part in the second direction are stuck to at least one shaft part of the pair of shaft parts to face each other while sandwiching the shaft part in the first direction;
detecting a strain in the second direction of the shaft part to which the pair of strain gauges are stuck, on the basis of a second voltage signal output from each of the pair of strain gauges in response to fastening of a nut from the other end of the shaft part to each of the pair of shaft parts inserted into a pair of through-holes provided in a fastening base; and
outputting data associated with fastening of the nut to the shaft part on the basis of the detected strain.

5. A measurement device, the measurement device comprises a processor configured to execute operations comprising:
fastening a U-bolt, wherein the U-bolt includes a pair of shaft parts aligned in a first direction and extending in a second direction orthogonal to the first direction, and a bridge part which connects one set of ends of each of the pair of shaft parts, and
a pair of strain gauges which output a first voltage signal corresponding to bending of the shaft part in the second direction are stuck to at least one shaft part of the pair of shaft parts to face each other while sandwiching the shaft part in the first direction;
detecting a strain in the second direction of the shaft part to which the pair of strain gauges are stuck, on the basis of a second voltage signal output from each of the pair of strain gauges in response to fastening of a nut from the other end of the shaft part to each of the pair of shaft parts inserted into a pair of through-holes provided in a fastening base; and
outputting data associated with fastening of the nut to the shaft part on the basis of the strain.

6. The U-bolt according to claim 1, wherein the bridge part represents in a shape curved in a semicircular shape, and the U-bolt in connection with the bridge part forms a U-shape.

7. The U-bolt according to claim 3, wherein the U-bolt is perpendicular to the fastened object.

8. The U-bolt according to claim 3, wherein the fastening object includes a support hardware.

9. The U-bolt according to claim 3, wherein the fastened object includes a piping.

10. The method according to claim 4, wherein the U-bolt further comprises:
a second pair of strain gauges, wherein the second pair of strain gauges is stuck to the at least one shaft part of the pair of shaft parts to face each other while sandwiching the shaft part in a third direction orthogonal to the first direction and the second direction, and the second pair of strain gauges outputs a second voltage signal corresponding to bending of the shaft part in the second direction.

11. The method according to claim 4, wherein, in a state in which the pair of shaft parts are inserted into a pair of through-holes provided in the fastening base, and a fastened object is sandwiched between the U-bolt and one surface of the fastening base and fixed, the strain gauge is entirely or partially positioned between the one surface of the fastening base and a boundary between the shaft part and the bridge part.

12. The method according to claim 4, wherein the bridge part represents in a shape curved in a semicircular shape, and the U-bolt in connection with the bridge part forms a U-shape.

13. The method according to claim 11, wherein the U-bolt is perpendicular to the fastened object.

14. The method according to claim 11, wherein the fastening object includes a support hardware.

15. The method according to claim 11, wherein the fastened object includes a piping.

16. The measurement device according to claim 5, wherein the U-bolt further comprises:
a second pair of strain gauges, wherein the second pair of strain gauges is stuck to the at least one shaft part of the pair of shaft parts to face each other while sandwiching the shaft part in a third direction orthogonal to the first direction and the second direction, and the second pair of strain gauges outputs a second voltage signal corresponding to bending of the shaft part in the second direction.

17. The measurement device according to claim 5, wherein, in a state in which the pair of shaft parts are inserted into a pair of through-holes provided in the fastening base, and a fastened object is sandwiched between the U-bolt and one surface of the fastening base and fixed, the strain gauge is entirely or partially positioned between the one surface of the fastening base and a boundary between the shaft part and the bridge part.

18. The measurement device according to claim 5, wherein the bridge part represents in a shape curved in a semicircular shape, and the U-bolt in connection with the bridge part forms a U-shape.

19. The measurement device according to claim 17, wherein the U-bolt is perpendicular to the fastened object.

20. The method according to claim 11, wherein the fastening object includes a support hardware, and the fastened object includes a piping.
